(19) United States
(12) Patent Application Publication
(10) Pub. No.: US 2025/0182341 A1
(43) Pub. Date: Jun. 5, 2025

(54) Rendering with Adaptive Frame Skip

(71) Applicant: Apple Inc., Cupertino, CA (US)

(72) Inventor: Chad B. Woolf, Gilroy, CA (US)

(21) Appl. No.: 18/946,616

(22) Filed: Nov. 13, 2024

Related U.S. Application Data
(60) Provisional application No. 63/606,368, filed on Dec. 5, 2023.

(51) Int. Cl. G06T 11/00; G06F 3/01; G06T 5/50; G06T 5/70; G06T 7/11; G06T 7/70; G06V 10/74; G06V 20/20

(52) U.S. Cl. CPC G06T 11/00; G06F 3/013; G06T 5/50; G06T 5/70; G06T 7/11; G06T 7/70; G06T 2207/20221; G06T 2207/30244; G06V 10/761; G06V 20/20

(57) ABSTRACT

Generating image frames based on the similarity of image content and pose information includes determining whether the image content of a first un-rendered image frame is sufficiently similar to the image content of a previously rendered image frame, and if so, determining whether the pose information of the first un-rendered image frame is sufficiently similar to the pose information of the previously rendered image frame. If both conditions are satisfied, the technique includes generating a second image frame using the previously rendered image content and the pose information of the first image frame.

### BACKGROUND

Rendering in an extended reality environment is a challenging task that requires high-performance graphics and efficient algorithms. Extended reality (XR) encompasses virtual reality (VR), augmented reality (AR), and mixed reality (MR), which create immersive and interactive experiences for the users. Rendering in XR involves generating realistic and consistent images of the virtual objects and scenes, and can involve blending generated content with images of a real-world environment.

One of the main challenges of rendering virtual content includes achieving high frame rates and low latency to improve user experience. Rendering frames is a resource-intensive process that consumes significant processing power. This can lead to performance issues, such as lagging, stuttering, or overheating. Therefore, improvements are needed to reduce the cost of the rendering process.

### BRIEF DESCRIPTION OF THE DRAWINGS

FIG. 1 shows a flow diagram of a technique for selectively rendering frames, according to one or more embodiments.

FIG. 2 shows a flow diagram of a technique for compositing frames using selectively rendered content, according to one or more embodiments.

FIG. 3 shows a flowchart of a technique for determining frame similarity, in accordance with some embodiments.

FIG. 4 shows a flowchart of a technique for determining similarity of a region of interest, in accordance with some embodiments.

FIG. 5 shows, in block diagram form, a simplified system diagram according to one or more embodiments.

FIG. 6 shows, in block diagram form, a computer system in accordance with one or more embodiments.

### DETAILED DESCRIPTION

This disclosure relates generally to image processing. More particularly, but not by way of limitation, this disclosure relates to techniques and systems for selectively rendering content for a mixed reality scene.

The present disclosure relates to a method for selectively rendering image frames based on the similarity of image content and pose information to previously rendered image frames. The technique includes determining whether the image content for a first image frame to be rendered is similar to the image content of a previously rendered image frame, and if so, determining whether the pose information of the first image frame is similar to the pose information of the previously rendered image frame. If both conditions are satisfied, the method generates a second image frame using the previously rendered image content and the pose information of the first image frame.

In some embodiments, determining the similarity of content across two image frames also considers other factors. As an example, head and eye tracking can be considered. If a person is fixated on a subject, the head and eyes will move together, thereby causing a region of interest to remain in a same place. As another example a renderer can skip rendering a frame, or reduce a rate at which frames are rendered, based on an eye status of the user. For example, when a user's eye moves rapidly, there will be a gap in time in which the user's brain is effectively remapping what is seen, and thus the user is not able to accurately interpret frames presented within that time period. Similarly, when a user blinks or closes the user's eyes, a renderer is rendering content which is presented to, but not viewed by, the user. Accordingly, a renderer may skip rendering certain frames, or reduce a rate at which frames are rendered, based on the eye status of the user.

Techniques described herein can reduce the computational cost and avoid unnecessarily producing heat, while improving the quality of image rendering by avoiding drawing the same image frame twice in a row. Accordingly, techniques described herein provide a technical improvement to previous methods by selectively rendering frames, thereby reducing latency and power consumption in the system.

A physical environment refers to a physical world that people can sense and/or with which they can interact without the aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood however that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system-and business-related constraints), and that these goals may vary from one implementation to another. It will also be appreciated that such development efforts might be complex and time-consuming, but would nevertheless be a routine undertaking for those of ordinary skill in the design and implementation of graphics modeling systems having the benefit of this disclosure.

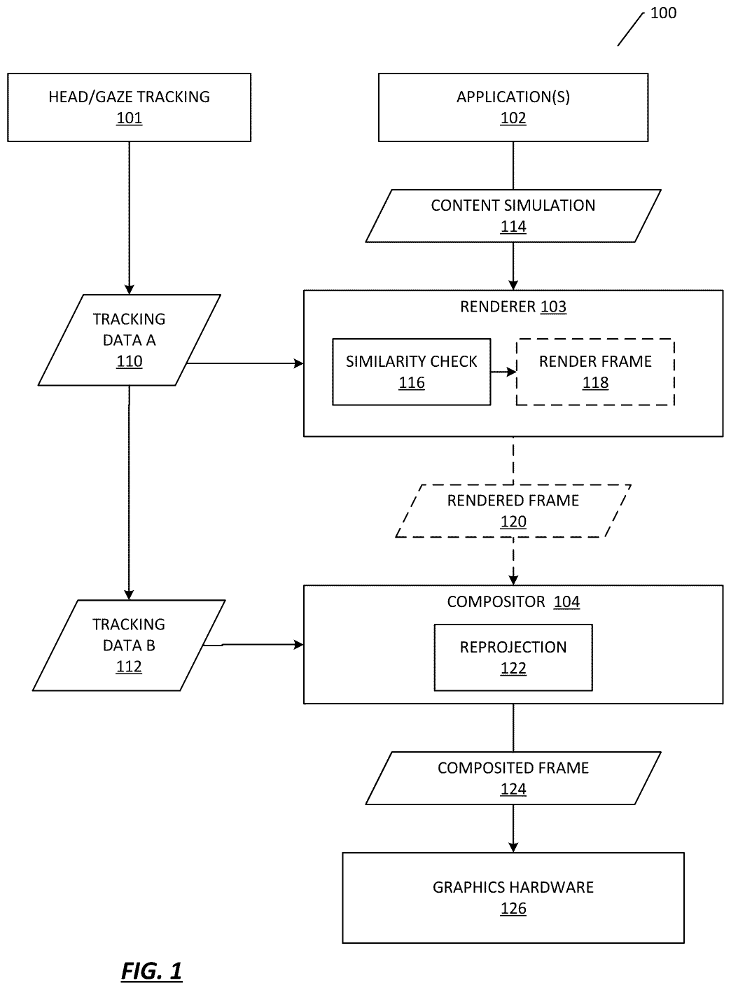

FIG. 1 depicts an example pipeline for generating a composite image based on camera data and virtual context, in accordance with one or more embodiments. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flow diagram 100 begins at block 101, where head and/or gaze tracking is performed. According to one or more embodiments, the system rendering and compositing the image data may be a head mounted device. Head tracking may be performed to determine a head pose of the user. Head tracking may be based on positional sensor data captured by a head mounted device, such as an inertial measurement unit (IMU), gyroscope, and/or a camera from which visual inertial odometry (VIO) techniques can be used to determine pose information for the device, such as a position and/or orientation. According to one or more embodiments, a head tracking technique can provide a head pose in the form of one or more values, such as a directional vector, or the like.

Gaze tracking data may include data generating, for example, by a gaze tracking network which is trained to predict gaze information such as a gaze vector based on sensor data collected of the user. For example, in some embodiments, the device can include user-facing cameras which capture image data of a subject (i.e., the user). The user-facing cameras can be configured to collect image data of a user's eyes. The image data of the user's eyes can be applied to an eye tracking network which is trained to predict a user's gaze vector based on image data containing the eyes of the user. The gaze vector may project from each eye, or from a point representative of the set of eyes, into the environment. The gaze vector may thereby be a directional vector pointing in the direction of the user's gaze. For example, the gaze vector may be used to determine an object or component of the environment at which the user's gaze is directed.

According to one or more embodiments, virtual content may be generated by one or more application(s) 102. The one or more application(s) 102 may produce content to be rendered for presentation on the user device. In some embodiments, the application may provide a content simulation 114, or other data indicative of content to be rendered by the renderer. The content simulation 114 may include, for example, a scene graph or other representation of the content to be rendered. For example, the content simulation 114 may include a data structure indicative of elements to be rendered as part of a scene, such as nodes of a tree. The elements within the content simulation 114 may include visual elements, audio elements, and the like. In some embodiments, the content simulation indicates components to be drawn during the rendering process.

The renderer 103 ingests the content simulation 114, and tracking data A 110. In some embodiments, the tracking data A 110 may be the most recent tracking data available at the time the content simulation 114 is obtained. According to some embodiments, the renderer 103 can use the tracking data A 110 to predict a head pose and/or gaze vector when the frame to be rendered is presented. That is, because the head and gaze can move faster than frames are rendered, the renderer 103 predicts how the frame should be rendered based on current gaze information, for better performance when the rendered frame is presented to the user. The head and/or gaze prediction may be used to render the frame in a particular manner. For example, more detail may be rendered in a region of the frame at which the user is gazing (or otherwise focused on), which can be estimated based on the head pose and/or gaze vector, as well as other sensor information and system context such as what applications are running and where they are located within the user's space. Thus, the renderer 103 is configured to render a frame based on content generated by the one or more application(s) 102 and in accordance with the content simulation 114, and additionally in accordance with tracking data A 110 and/or a gaze prediction based on tracking data A 110.

At block 116, the renderer 103 performs a similarity check by comparing a current frame to be rendered to the most recent previously rendered frame. The similarity check may determine whether a current frame to be rendered would be visually equivalent to the previously rendered frame. For example, a determination may be made as to whether a similarity condition is satisfied based on a comparison of the image content for the un-rendered frame and image content of the previously rendered frame. In some embodiments, the similarity condition may be determined to be satisfied based on a similarity of the visual components of content to be rendered as received by the one or more application(s) 102, and/or other characteristics that may impact how the frame is rendered, such as gaze and/or head pose from tracking data A 110. In some embodiments, the similarity condition is based on a determination of a perceivable difference between the content of the un-rendered image data and content of the prior-rendered image data.

According to one or more embodiments, the similarity check includes comparing visual elements of the current content simulation 114 to the visual elements of a prior content simulation which was used to render the previously rendered frame. For example, visual elements of a scene graph from a current content simulation may be compared to visual elements of a prior scene graph for a prior rendered frame. In some embodiments, the visual elements may include a structural change based on the content simulation 114 that surpasses a threshold level of acceptability.

In some embodiments, the similarity check 116 may rely on known limitations or other characteristics of a reprojection algorithm to be applied to the frame later in the pipeline, such as by the compositor 104. For example, the tracking data A 110 may be used to determine whether a previously rendered frame has all the data, or a sufficient amount of data satisfying a predefined threshold, to be reprojected by a compositor in accordance with an updated head pose and/or gaze vector, either determined based on current tracking data A 110 or predicted for when the frame is to be displayed. For example, a foveation technique can be applied such that a portion of the frame at which the viewer is gazing is rendered in greater detail than other regions of the frame. As another example, if a translational movement of a user's head does not exceed a predetermined threshold, then the current frame to be rendered may be determined to be sufficiently similar to the prior rendered frame. By contrast, if the head movement causes new pixels (or, in some embodiments, a threshold amount of new pixels) to be rendered which are not available in the prior rendered frame, for example due to occlusion, then the similarity check 116 may determine that the current frame to be rendered is not sufficiently similar to the prior rendered frame.

Although not shown, the similarity check 116 may rely on additional data or parameters used for rendering frames. This may include, for example, characteristics from the physical environment or treatments applied in accordance with a camera capturing pass-through camera frames, such as blur, lighting, and the like. The similarity check 116 may determine whether a change in these additional parameters would cause a change in the visual appearance of the current frame to be rendered to exceed a threshold amount of visual change from a prior rendered frame. For example, lighting information on the surrounding real-world environment may be estimated based on camera images and used by the renderer to help match the lighting of the rendered content with pass-through content. Thus, if the lighting conditions of the real-world environment change, then it may be desirable to render new virtual content, rather than re-use a previously rendered frame that may not match the new lighting conditions.

According to one or more embodiments, the renderer 103 only renders the current frame 118 if the similarity check 116 indicates that the frame to be rendered is not substantially similar to the prior rendered frame. If the current frame is not substantially similar to the prior rendered frame, then the frame is rendered at 118. If the current frame is substantially similar to the prior rendered frame, then the renderer 103 skips rendering the current frame. In some embodiments, the renderer 103 may skip rendering the frame 118 based on additional reasons. For example, if the tracking data A 110 indicates than a user is blinking, then a rendering rate may be slowed, such that the renderer 103 skips ever other frame, or renders frames at a slower rate such that not every available frame is rendered. As another example, if the tracking data A 110 indicates that an eye is moving quickly, a user may not be able to interpret frames generated at a full render rate. As such, frames may be rendered at a reduced rate, such that some frames are skipped. Thus, the renderer 103 may rely on an eye status from tracking data A 110 in addition to, or in place of, the similarity from content simulation 114 in accordance with one or more embodiments. If the frame is rendered, then the rendered frame 120 is passed to the compositor 104.

According to one or more embodiments, the compositor 104 obtains tracking data B 112, which may be the most current tracking data provided by head/gaze tracking 101 at the time the compositor 104 composites a particular frame to obtain composited frame 124. As such, tracking data B 112 may be the same or different than tracking data A 110. The compositor may use rendered frame 120 to generate a composited frame, or if a rendered frame 120 is not received for a particular frame, then the compositor 104 may generate a composited frame from a rendered frame most recently received from renderer 103. In some embodiments, the compositor 104 may generate stereo frames, such that a left eye frame and a right eye frame are generated. The compositor 104 can obtain virtual content from the renderer 103 and, optionally, pass-through camera frames or other image data from which a final frame is to be composited. The compositor 104 may perform a reprojection 122 by using the tracking data B 112 and adjusting the most recently received rendered frame based on where a user is determined to be viewing, or predicted to be viewing, based on tracking data B 112. To the extent that the renderer 103 and/or compositor 104 are separate from a dedicated graphics hardware 126, the composited frame 124 may be passed to a graphics hardware 126 which prepares and provides the frame to a display component of the system.

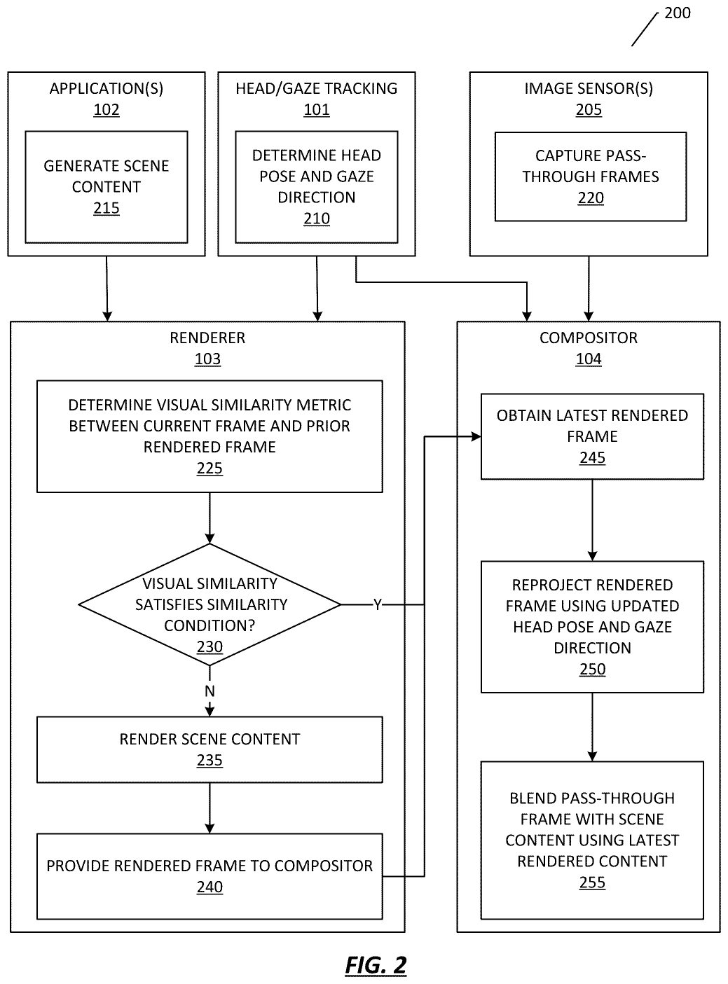

According to some embodiments, the selective rendering technique can be used for a variety of uses, such as virtual reality content, in which frames are rendered using fully virtual content. As an alternative, a mixed reality frame may be rendered, for example using pass-through camera image data. FIG. 2 shows a flow diagram of a technique for compositing frames using selectively rendered content, according to one or more embodiments. In particular, FIG. 2 shows an example flow for generating a composite image using virtual content and pass-through image content. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

Initially, the flow diagram 200 begins with content and data being generated by a head tracking component 101, one or more application(s) 102, and one or more image sensor(s) 205. The content generated by these three components is used to generate the composite image which is to be used to generate a composite image presented on a display.

To begin, one or more application(s) 102 generate scene content, as shown at block 215. The one or more application(s) 102 may include more than one application and may include more than one types of applications. For example, multiple applications may contribute their scene graphs to a renderer, which maintains a shared graph. According to one or more embodiments, virtual content may be generated by one or more application(s) 102. The one or more application(s) 102 may produce content to be rendered for presentation on the user device. In some embodiments, the application may provide a content simulation, or other data indicative of content to be rendered by the renderer. For example, the one or more application(s) 102 may produce a scene graph or other representation of the content to be rendered.

In addition, the flow diagram 200 begins with a head/gaze tracking component 101 determining a head pose and/or a gaze direction, as shown at block 210. As described above, head tracking may be performed to determine a head pose of a user, and may be based on positional sensor data captured by a head mounted device, such as an inertial measurement unit (IMU), gyroscope, and/or a camera from which visual inertial odometry (VIO) techniques can be used to determine pose information for the device. In some embodiments, the device pose may be used as a substitute for head pose. Additionally, or alternatively, the device pose may be used to derive the head pose information based on known characteristics of a general user's head and/or a specific user's head, and the device. According to one or more embodiments, a head tracking technique can provide a head pose in the form of one or more values for position and/or orientation, such as a directional vector, or the like. Gaze tracking data may include data generated, for example, by a gaze tracking network which is trained to predict a gaze vector based on sensor data collected of the user. For example, in some embodiments, the device can include user-facing cameras which capture image data of the user. In some embodiments, the gaze vector may be used to determine an object or component of the environment at which the user's gaze is directed.

Further, the flow diagram 200 begins with one or more image sensor(s) 205 capturing pass-through frames, as shown at block 220. The one or more image sensor(s) 205 may be part of one or more pass-through camera(s), such as front facing on a head mounted device configured to capture image data of a scene. The pass-through frames may be captured at a rate that is the same or different than the rate at which the scene content is generated, and/or at which head/gaze tracking data is determined.

The renderer 103 receives the generated scene content from block 215, and the head pose and gaze direction from block 210, and the flowchart proceeds to block 225, where the renderer determines a visual similarity metric between a current frame and a prior rendered frame. As described above, the similarity metric may be determined based on changes to the scene content from a prior rendered frame to the current frame. Additionally, or alternatively, the similarity metric may be based on changes to an eye status, such as a head pose and/or gaze direction that was used for a prior rendered frame to the current frame. The similarity metric may be determined based on whether an amount and/or type of difference between the two frames is sufficient for using the same rendered frame from a prior rendered frame for generating a next composite frame. For example, the similarity metric may be based on part or all of the scene graph, or particular portions of the scene graph. Further, the similarity metric may be based on other characteristics that affect the visual appearance of the content when rendered, such as room lighting changes. As another example, scene understanding may be used to determine whether new options or portions of objects become visible that would result in differently rendered content, such as a shadow. As such, the similarity metric may include a determination based on scene content, system limitations, and the like to determine whether the current frame to be rendered satisfies a similarity threshold, such as by using acceptable ranges of changes between two frames, either generally, or for the types of differences between the two frames.

The flow diagram 200 proceeds to block 230, where a determination is made as to whether the visual similarity satisfies a similarity condition. The similarity condition may be satisfied, for example, if the similarity threshold for a particular difference between the two frames is satisfied. As another example, the similarity threshold may be based on an eye status, such as if the two frames are substantially similar based on whether a user could interpret the difference based on eye status. Thus, the similarity condition may indicate that the difference between the current frame to be rendered and a prior rendered frame is interpretable to a user. The similarity condition may spatially vary across a frame and/or be based on gaze. For example, the similarity condition may be relaxed in the periphery of the user's current gaze direction, such that a greater amount of visual change to content in the user's periphery (relative to content in a region around the user's fovea) is permitted before content is re-rendered.

If a determination is made at block 230 that the similarity condition is not satisfied, then the flow diagram 200 proceeds to block 235, where the renderer renders the scene content. That is, if the current frame to be rendered and the prior rendered frame are not substantially similar, then the current frame is rendered using the scene content. That is, a frame is rendered based on the scene content generated at block 215 and in accordance with a determined head pose and gaze direction from block 210. Then at block 240, the render 103 provides the rendered frame to the compositor 104.

The flow diagram 200 continues to block 245, where the compositor 104 obtains the latest rendered frame 245. That is, if at block 230, the visual similarity satisfied a similarity condition, then the frame to be rendered is skipped, and the compositor uses the prior rendered frame. By contrast, if a determination is made a block 230 that the visual similarity between the current frame to be rendered and the prior rendered frame does not satisfy a similarity condition, then the compositor 104 obtains the rendered frame provided at block 240.

The flow diagram 200 proceeds to block 250, where the compositor 104 reprojects the rendered frame using head/gaze tracking. The compositor 104 may perform a reprojection by using the tracking data received from head/gaze tracking 101, and adjusting the most recently received rendered frame based on where a user is determined to be viewing, or predicted to be viewing, based on head/gaze tracking. According to one or more embodiments, the compositor may use the same head and/or gaze tracking information used by renderer 103 to determine similarity. Additionally, or alternatively, the compositor 104 may use more up-to-date tracking information which may have been generated since the renderer 103 used the tracking information. As such, a prediction for a head pose and/or gaze direction at the time of display may be more up to date or more accurate when using more recent tracking data at the compositor than when using the tracking data available to the renderer when the frame was rendered.

The flow diagram 200 concludes at block 255, where the compositor 104 uses the pass-through camera frames from image sensor(s) 205, and generate a composite image using the pass-through frames and the reprojected content from the rendered frame. As such, the scene content for a currently composited frame may be the same as a prior-rendered frame, but may be composited onto a more recent pass-through frame in accordance with more recent tracking data.

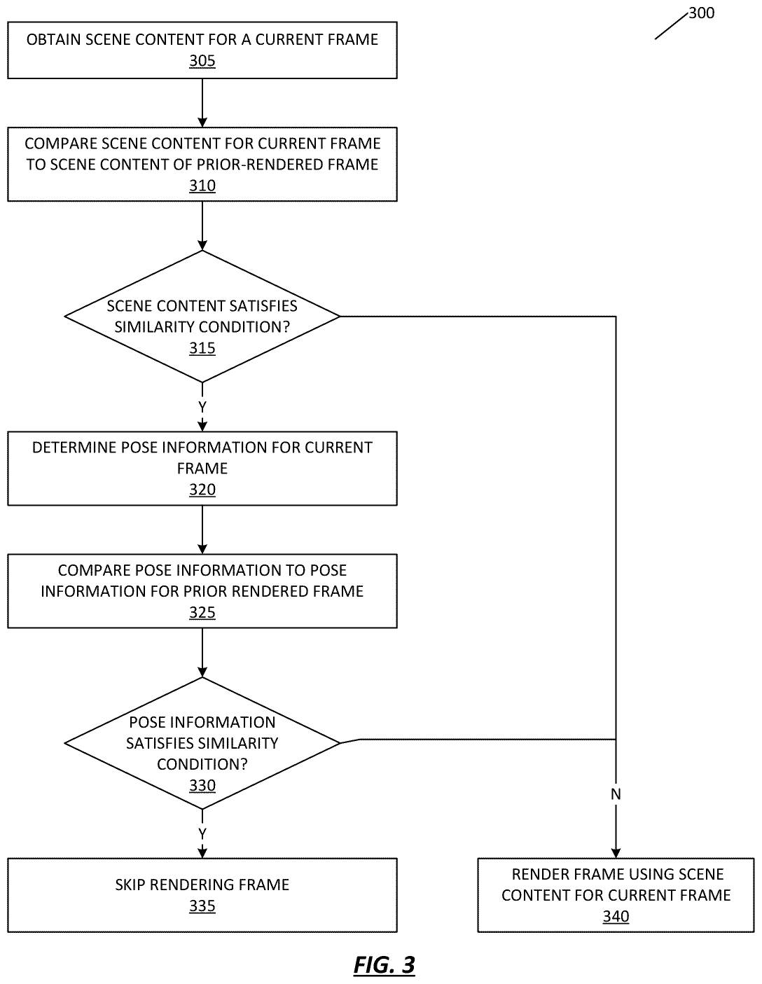

FIG. 3 shows a flowchart of a technique for determining frame similarity, in accordance with some embodiments. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 300 begins at block 305, where scene content is obtained for a current frame. According to one or more embodiments, scene content may be content generated by one or more applications. In some embodiments, scene content may be provided in the form of a content simulation, or other data structure indicative of content to be rendered by the renderer. For example, an application may produce a scene graph or other representation of the content to be rendered.

The flowchart continues to block 310, where the scene content for a current frame is compared to scene content used to render a prior rendered frame. As such, the fully rendered frame does not need to be compared pixel-to-pixel. Rather, the code and components that result in the rendered frame are compared to determine whether the resulting rendered frame would appear the same.

At block 315, a determination is made as to whether the scene content satisfies a similarity condition. According to one or more embodiments, the similarity threshold may be based on an eye status, such as if the two frames are substantially similar based on whether a user could interpret the difference based on eye status. Thus, the similarity condition may indicate that the difference between the current frame to be rendered and a prior rendered frame is interpretable to a user. As such, the similarity condition may be based on an amount of one or more types of changes at which the content of the frame is determined to be discernible. Examples of the types of differences may include changes to the structure of the scene, head movement causing a portion of the scene to become visible which were hidden in a prior frame. As another example, the scene content may include a portion of content which is known to be changed every time it is rendered, for example in a randomly generated fashion. Accordingly, the renderer would need to know the content is in the scene to render each frame. If at block 315, a determination is made that the scene content satisfies a similarity condition, then the flowchart concludes at block 340, and the renderer renders a current frame using scene content for the current frame. Said another way, if the scene content is substantially different in the current frame to be rendered and a prior rendered frame, then the current frame is rendered by the renderer.

Returning to block 315, if a determination is made that the scene content satisfies a similarity threshold, then the flowchart 300 proceeds to block 320, and pose information is determined for a current frame. Pose information may include a determination of a head pose and/or gaze tracking of a user. As described above, head tracking may be performed to determine a head pose of a user. In some embodiments, the device pose may be used as a substitute for head pose. Additionally, or alternatively, the device pose may be used to derive the head pose information based on known characteristics of a general user's head and/or a specific user's head, and the device. According to one or more embodiments, a head tracking technique can provide a head pose in the form of one or more values for position and/or orientation, such as a directional vector, or the like. Gaze tracking data may include data generating, for example, by a gaze tracking network which is trained to predict a gaze vector based on sensor data collected of the user. For example, in some embodiments, the device can include user-facing cameras which capture image data of the user. In some embodiments, the gaze vector may be used to determine an object or component of the environment at which the user's gaze is directed.

At block 325, the pose information for the current frame to be rendered is compared to pose information for a prior rendered frame to determine a pose similarity metric. The pose similarity metric may be based on a type of difference between a head pose in a prior rendered frame and a current frame to be rendered, such as a translational movement, rotation, or the like. A determination is made at block 330 as to whether the pose information satisfies a similarity condition. The similarity condition may be based on how much of the frame to be rendered is not captured in the prior rendered frame, in accordance with the head movement defined by the pose. If the pose information does not satisfy a similarity condition, then the flowchart concludes at block 340, and the renderer renders a current frame using scene content for the current frame.

Returning to block 330, if a determination is made that the pose information satisfies the similarity condition, then the flowchart 300 concludes at block 335, and the renderer skips rendering the frame. As such, the compositor may use the prior rendered frame for generating a composite image for presentation to a user.

Although not shown, in some embodiments, a maximum number of frames may be skipped such that even if the similarity conditions are satisfied, if a number of frames exceeds a maximum allowed number of frames to be skipped, or a time limit is exceeded which is a predefined maximum time for which frames are to be skipped, then the renderer renders a current frame using scene content for the current frame. For example, a time between the prior rendered frame and a current frame may be used to determine whether a timeout condition is satisfied.

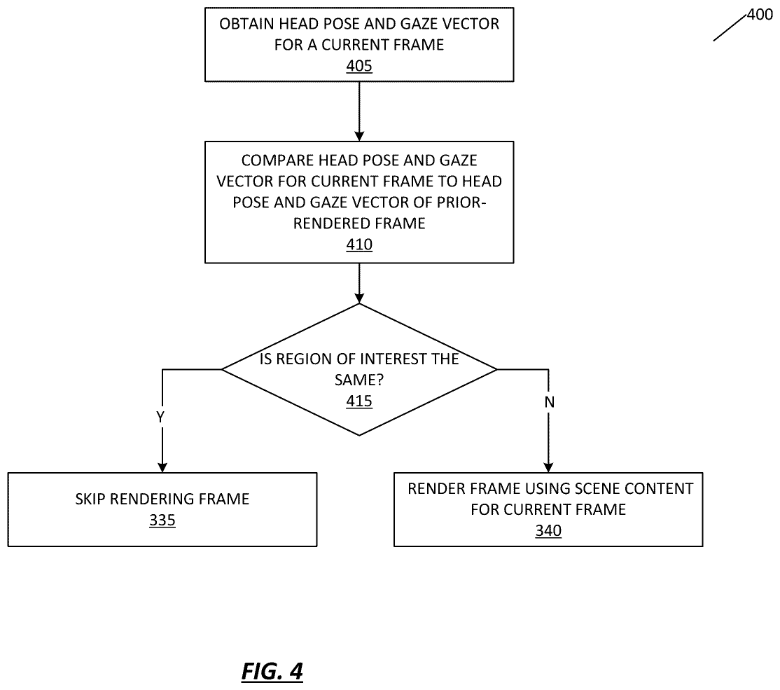

According to some embodiments, other treatments may be applied to frames which may impact the visual appearance of the virtual content when presented to the user. In particular, a region of interest for a particular frame may be rendered differently than other regions of the frame, such as when a foveation treatment is applied. FIG. 4 shows a flowchart of a technique for determining similarity of a region of interest, in accordance with some embodiments. In particular, the techniques described in FIG. 4 can be implemented in the flowchart of FIG. 3 prior to rendering the frame using scene content for the current frame at block 340. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 400 begins at block 405, where head pose and gaze vectors are obtained for a current frame. According to one or more embodiments, the head pose may correspond to a position and/or direction. A head tracking technique can provide a head pose in the form of one or more values, such as a directional vector, or the like.

At block 410, the head pose and gaze vectors from the current frame are compared to head pose and gaze vectors for a prior rendered frame. According to one or more embodiments, the head pose and gaze vectors are compared to determine whether a user is gazing at a same position of the content. For example, if a user's eyes are tracking a virtual object, then the region of the frame having that virtual object will align with the gaze vector. In some scenarios, a head pose and gaze vector may change at the same time in opposite directions, effectively canceling out the movements. For example, if the user moves the user's head to the left, but adjusts the user's gaze vector to stay focused on an object, the frame comprising the object will remain the same. As a result, although the head pose and gaze are moving, the region of interest will remain the same.

At block 415, a determination is made regarding whether the region of interest is the same for a frame to be rendered as compared to a prior rendered frame. A region of interest may be defined, for example, based on a region of the scene a user is viewing. This may be determined, for example, based on gaze information. Additionally, or alternatively, the region of interest may be a region of the frame to be drawn in greater detail by the renderer than other regions of the frame. According to some embodiments, determining whether the region of interest is the same may include determining whether the region of interest in a frame to be rendered is within a threshold distance of the region of interest in a prior rendered frame. If a determination that the region of interest is the same, and if the scene content and pose information also satisfy one or more similarity conditions, then the flowchart concludes at block 335 of FIG. 3 and the renderer skips rendering the frame. As such, the compositor may use the prior rendered frame for generating a composite image for presentation to a user.

Returning to block 415, if a determination is made that the region of interest is not the same, then the flowchart 400 concludes at block 340 of FIG. 3 and the renderer renders a current frame using scene content for the current frame. Said another way, if the scene content is substantially different in the current frame to be rendered and a prior rendered frame, then the current frame is rendered by the renderer.

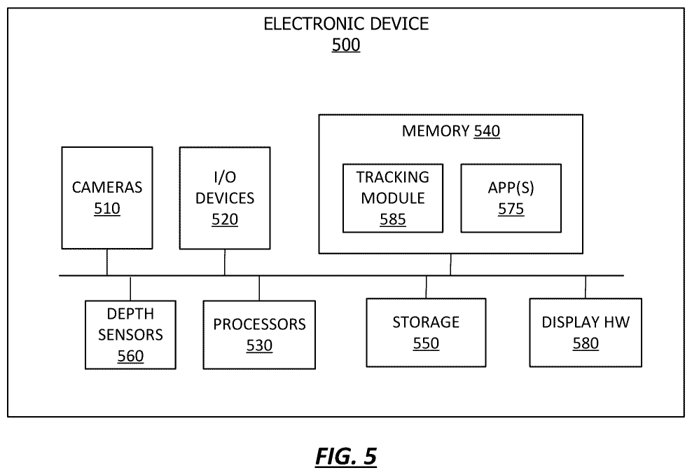

Referring to FIG. 5, a simplified block diagram of an electronic device 500 which may be utilized to generate and display mixed reality scenes. The system diagram includes electronic device 500 which may include various components. Electronic device 500 may be part of the multifunctional device, such as phone, tablet computer, personal digital assistant, portable music/video player, wearable device, base station, laptop computer, desktop computer, network device, or any other electronic device that has the ability to capture image data.

Electronic device 500 may include one or more processor(s) 530, such as a central processing unit (CPU). Processor(s) 530 may include a system-on-chip such as those found in mobile devices and include one or more dedicated graphics processing units (GPUs) or other graphics hardware. Further, processor(s) 530 may include multiple processors of the same or different type. Electronic device 500 may also include a memory 540. Memory 540 may include one or more different types of memory, which may be used for performing device functions in conjunction with processors 530. Memory 540 may store various programming modules for execution by processor(s) 520, including tracking module 585, and other various applications 575 which may produce virtual content. Electronic device 500 may also include storage 550. Storage 550 may include data utilized by the tracking module 585 and/or applications 575. For example, storage 550 may be configured to store user profile data, media content to be displayed as virtual content, and the like.

In some embodiments, the electronic device 500 may include other components utilized for vision-based tracking, such as one or more cameras 510 and/or other sensors, such as one or more depth sensors 560. In one or more embodiments, each of the one or more cameras 510 may be a traditional RGB camera, a depth camera, or the like. Further, cameras 510 may include a stereo or other multi camera system, a time-of-flight camera system, or the like which capture images from which depth information of the scene may be determined. Cameras 510 may include cameras incorporated into electronic device 500 capturing different regions. For example, cameras 510 may include one or more scene cameras and one or more user-facing cameras, such as eye tracking cameras or body tracking cameras.

In one or more embodiments, tracking module 585 may track user characteristics, such as a position of the user's head, a gaze direction, or the like. The tracking module 585 may determine whether a target gaze position changes from one frame to another based on the user's head pose and/or gaze direction.

Although electronic device 500 is depicted as comprising the numerous components described above, and one or more embodiments, the various components and functionality of the components may be distributed differently across one or more additional devices, for example across a network. In some embodiments, any combination of the data or applications may be partially or fully deployed on additional devices, such as network devices, network storage, and the like. Similarly, in some embodiments, the functionality of tracking module 585 and applications 575 may be partially or fully deployed on additional devices across a network.

Further, in one or more embodiments, electronic device 500 may be comprised of multiple devices in the form of an electronic system. Accordingly, although certain calls and transmissions are described herein with respect to the particular systems as depicted. In one or more embodiments, the various calls and transmissions may be differently directed based on the differently distributed functionality. Further, additional components may be used, or some combination of the functionality of any of the components may be combined.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display 580. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

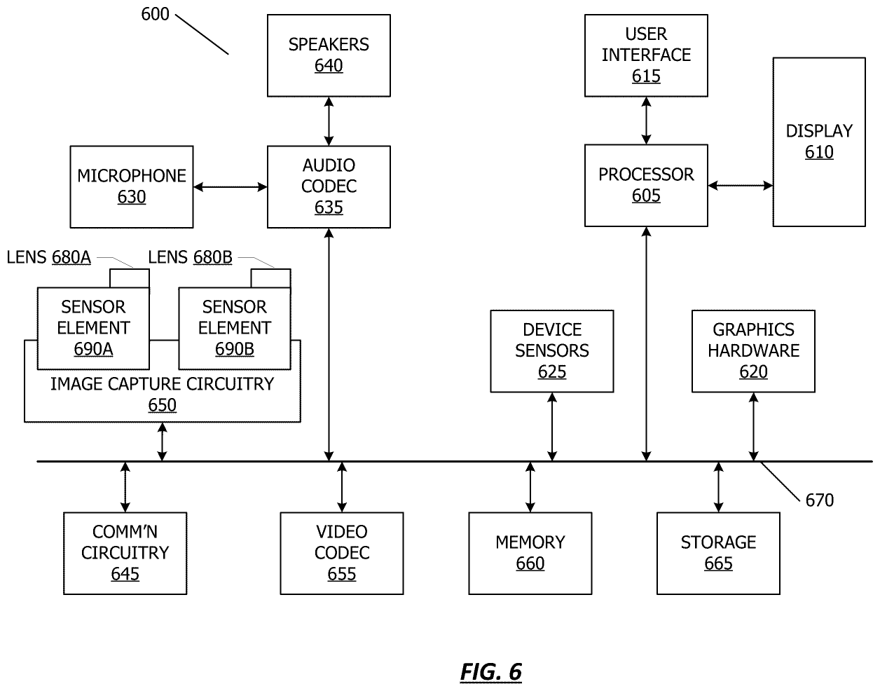

Referring now to FIG. 6, a simplified functional block diagram of illustrative multifunction electronic device 600 is shown according to one embodiment. Each of electronic devices may be a multifunctional electronic device, or may have some or all of the described components of a multifunctional electronic device described herein. Multifunction electronic device 600 may include processor 605, display 610, user interface 615, graphics hardware 620, device sensors 625 (e.g., proximity sensor/ambient light sensor, accelerometer and/or gyroscope), microphone 630, audio codec(s) 635, speaker(s) 640, communications circuitry 645, digital image capture circuitry 650 (e.g., including camera system) video codec(s) 655 (e.g., in support of digital image capture unit), memory 660, storage device 665, and communications bus 670. Multifunction electronic device 600 may be, for example, a digital camera or a personal electronic device such as a personal digital assistant (PDA), personal music player, mobile telephone, or a tablet computer.

Processor 605 may execute instructions necessary to carry out or control the operation of many functions performed by device 600 (e.g., such as the generation and/or processing of images as disclosed herein). Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen and/or a touch screen. Processor 605 may also, for example, be a system-on-chip such as those found in mobile devices and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still and/or video images. Output from image capture circuitry 650 may be processed, at least in part, by video codec(s) 655 and/or processor 605 and/or graphics hardware 620, and/or a dedicated image processing unit or pipeline incorporated within image capture circuitry 650. Images so captured may be stored in memory 660 and/or storage 665.

Image capture circuitry 650 may capture still and video images that may be processed in accordance with this disclosure, at least in part, by video codec(s) 655 and/or processor 605 and/or graphics hardware 620, and/or a dedicated image processing unit incorporated within image capture circuitry 650. Images so captured may be stored in memory 660 and/or storage 665. Memory 660 may include one or more different types of media used by processor 605 and graphics hardware 620 to perform device functions. For example, memory 660 may include memory cache, read-only memory (ROM), and/or random-access memory (RAM). Storage 665 may store media (e.g., audio, image, and video files), computer program instructions or software, preference information, device profile information, and any other suitable data. Storage 665 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to tangibly retain computer program instructions or code organized into one or more modules and written in any desired computer programming language. When executed by, for example, processor 605 such computer program code may implement one or more of the methods described herein.

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies.

The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions or the arrangement of elements shown should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory computer readable medium comprising computer readable code to:
in accordance with a determination that first image content of a first rendered image frame and second image content for a first un-rendered frame satisfy a first similarity condition:
determine first pose information for the first rendered image frame, and
determine second pose information for the second image content, and
in accordance with a determination that the first pose information and the second pose information satisfies a second similarity condition, generate a second image frame using the first image content from the first rendered image frame and the second pose information.

2. The non-transitory computer readable medium of claim 1, wherein the computer readable code to generate the second image frame comprises computer readable code to:
reproject the first image content based on the second pose information.

3. The non-transitory computer readable medium of claim 1, wherein the computer readable code to generate the second image frame comprises computer readable code to:
determine a first region of interest based on first gaze information for the first rendered image frame;
determine a second region of interest for the second image content based on second gaze information corresponding to the second image content; and
generate the second image frame using the first image content and the second pose information in response to a determination that the first region of interest and the second region of interest satisfy a third similarity condition.

4. The non-transitory computer readable medium of claim 1, wherein the computer readable code to generate the second image frame further comprises computer readable code to:
blend a pass-through camera frame with the second image content.

5. The non-transitory computer readable medium of claim 1, wherein the computer readable code to determine that first image content of a first rendered image frame and second image content for a first un-rendered frame satisfy a first similarity condition further comprises computer readable code to:
obtain a first simulation corresponding to the first image content,
obtain a second simulation corresponding to the second image content, and
compare the first simulation and the second simulation to determine whether difference between the first simulation and the second simulation affects a visual appearance of a corresponding frame when rendered.

6. The non-transitory computer readable medium of claim 1, wherein the first similarity condition is based on a perceivable difference between the first image content and the second image content.

7. The non-transitory computer readable medium of claim 1, wherein the second similarity condition is based on a limitation of a reprojection algorithm used to generate the second image frame using the first rendered content and the second pose information.

8. A method comprising:
in accordance with a determination that first image content of a first rendered image frame and second image content for a first un-rendered frame satisfy a first similarity condition:
determining first pose information for the first rendered image frame,
determining second pose information for the second image content, and
in accordance with a determination that the first pose information and the second pose information satisfies a second similarity condition, generating a second image frame using the first image content from the first rendered image frame and the second pose information.

9. The method of claim 8, wherein the second similarity condition is based on a limitation of a reprojection algorithm used to generate the second image frame using the first rendered content and the second pose information.

10. The method of claim 9, wherein the prior rendered image frame is reprojected using the prior pose information and the prior rendered content, and wherein the first rendered image frame is reprojected using the first pose information and the prior rendered content.

11. The method of claim 8, wherein generating the second image frame using the first rendered content and the second pose information comprises skipping rendering a frame with the second image content.

12. The method of claim 11, wherein generating the second image frame using the first image content and the second pose information comprises:
identifying, by a compositor, that the first image content is a most recent rendered content received from a renderer.

13. The method of claim 8, wherein generating the second image frame using the first rendered content and the second pose information further comprises determining that the first image content and second image content satisfy a timeout condition.

14. A system comprising:
one or more processors; and
one or more computer readable media comprising computer readable code executable by the one or more processors to:
in accordance with a determination that first image content of a first rendered image frame and second image content for a first un-rendered frame satisfy a first similarity condition:
determine first pose information for the first rendered image frame, and
determine second pose information for the second image content, and
in accordance with a determination that the first pose information and the second pose information satisfies a second similarity condition, generate a second image frame using the first image content from the first rendered image frame and the second pose information.

15. The system of claim 14, wherein the computer readable code to generate the second image frame comprises computer readable code to:
reproject the first image content based on the second pose information.

16. The system of claim 14, wherein the computer readable code to generate the second image frame comprises computer readable code to:
determine a first region of interest based on first gaze information for the first rendered image frame;
determine a second region of interest for the second image content based on second gaze information corresponding to the second image content; and
generate the second image frame using the first image content and the second pose information in response to a determination that the first region of interest and the second region of interest satisfy a third similarity condition.

17. The system of claim 14, wherein the computer readable code to generate the second image frame further comprises computer readable code to:
blend a pass-through camera frame with the second image content.

18. The system of claim 14, wherein the computer readable code to determine that first image content of a first rendered image frame and second image content for a first un-rendered frame satisfy a first similarity condition further comprises computer readable code to:
obtain a first simulation corresponding to the first image content,
obtain a second simulation corresponding to the second image content, and
compare the first simulation and the second simulation to determine whether difference between the first simulation and the second simulation affects a visual appearance of a corresponding frame when rendered.

19. The system of claim 14, wherein the first similarity condition is based on a perceivable difference between the first image content and the second image content.

20. The system of claim 14, wherein the second similarity condition is based on a limitation of a reprojection algorithm used to generate the second image frame using the first rendered content and the second pose information.
